(19) United States
(12) Patent Application Publication
(10) Pub. No.: US 2005/0020308 A1
(43) Pub. Date: Jan. 27, 2005

(54) Dynamically binding Subscriber Identity Modules (SIMs)/User Identity Modules (UIMs) with portable communication devices

(76) Inventor: David Lai, Alviso, CA (US)

Correspondence Address: Shemwell Gregory & Courtney LLP;Suite 201, 4880 Stevens Creek Boulevard, San Jose, CA, 95129, US

(21) Appl. No.: 10/626,411

(22) Filed: Jul. 23, 2003

(51) Int. Cl. H04M 1/00; H04B 1/38

(52) U.S. Cl. 455/558; 455/550.1

(57) ABSTRACT

Communication devices are provided for use in a communication network, where the devices include a control subsystem that forms an electronic linkage between the device and a removeably coupled identity module. The control subsystem receives identification information of device components and the identity module and, in response, dynamically links the device to the identity module by writing the identification information to a binding file along with an assigned device identification corresponding to the device and identity module combination. The binding file is in a memory area of the identity module. The information of the binding file controls subsequent activation and operation of the device in a communication network. Therefore, the control subsystem supports use of a single identity module, for example a Subscriber Identity Module (SIM)/User Identity Module (UIM), among many devices.

### TECHNICAL FIELD

The disclosed embodiments relate to portable communication devices.

### BACKGROUND

A variety of portable communication devices are currently available that support mobile communications and information transfer via network connectivity. For example, typical cellular telephones support mobile communications that include voice communication, text messaging, and data transfer. While the typical communication device can support the transfer of multiple information types, the device can not generally support communication with multiple network protocols.

The absence of a standard network protocol that is used in all telecommunication networks results in a requirement that a communication device be specifically configured for use with a corresponding network. As such, a user who travels among different communication networks where the different networks use different protocols is required to use multiple communication devices, with each device being configured for communication using a particular communication protocol.

In particular telecommunications networks, Subscriber Identity Module (SIM)/User Identity Module (UIM) cards are used to control access to a communications network by a communication device to which they arc coupled. For example, SIM/UIM cards can control access by a user to a telecommunications device such as a cellular telephone which will receive the SIM/UIM card. The SIM/UIM card is used primarily to provide a customer profile from which the customer may be billed for usage of the telecommunications network. Thus, the SIM/UIM card is used to authenticate or authorize a user and provide subscriber identification, billing information and other information concerning the operation of the telephone. The SIM/UIM card typically comprises a card having electronic components which is inserted into a particular telephone in order to enable operation of the telephone.

A typical SIM card can be assigned to a user and used to enable voice communications across numerous devices and networks because the presence of the SIM card enables operation of the telephone and subscriber information of the SIM card is not required for billing. Therefore, while a user is still required to have multiple communication devices for communication via multiple networks, the user can have a single account to which all network usage is billed via the SIM card. While the SIM card enables voice communications because it enables use of the phone, however, the SIM card can not be used to support data transfer across multiple portable communication devices because the subscriber information stored on the SIM card is needed to bill data transfers and the SIM cards generally can not be read by multiple communication devices.

### BRIEF DESCRIPTION OF THE FIGURES

FIG. 1 is a block diagram of a communication network including a portable communication device that dynamically binds to a SIM/UIM card, under an embodiment.

FIGS. 2A, 2B, and 2C show a flow diagram for dynamically binding SIM/UIM cards to portable communication devices, under the embodiment of FIG. 1.

FIG. 3 is a block diagram of an example including a SIM/UIM card that dynamically binds to multiple portable communication devices, under the embodiments of FIG. 1 and FIGS. 2A, 2B, and 2C.

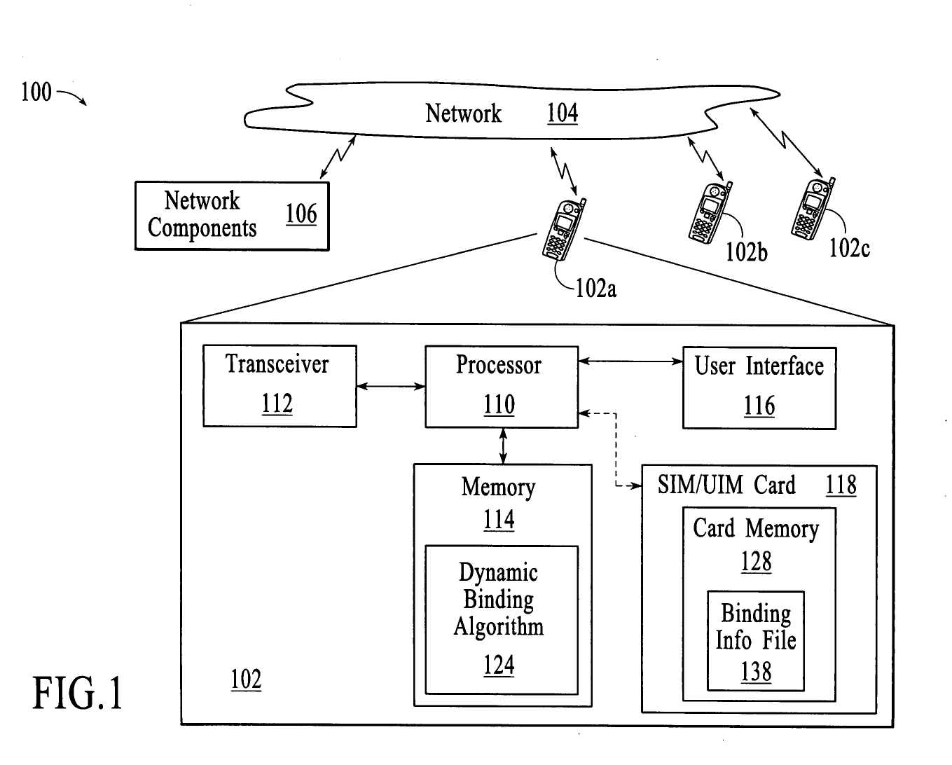

In the drawings, the same reference numbers identify identical or substantially similar elements or acts. To easily identify the discussion of any particular element or act, the most significant digit or digits in a reference number refer to the Figure number in which that element is first introduced (e.g., element 124 is first introduced and discussed with respect to FIG. 1).

### DETAILED DESCRIPTION

Communication devices are described in detail herein for use in a communication network, where the devices include a control subsystem that forms an electronic linkage between the device and a removeably coupled identity module. The control system of an embodiment comprises at least one processor of the communication device running under the control of a program, routine, or algorithm, but is not so limited. The control subsystem receives identification information of device components and the identity module and, in response, dynamically links the device to the identity module by writing the identification information to a binding file along with an assigned device identification corresponding to the device and identity module combination. The binding file is in a memory area of the identity module. The information of the binding file controls subsequent activation and operation of the device in a communication network. Therefore, the control subsystem supports use of a single identity module, for example a Subscriber Identity Module (SIM)/User Identity Module (UIM), among many devices.

In the following description, numerous specific details are introduced to provide a thorough understanding of, and enabling description for, embodiments of the invention. One skilled in the relevant art, however, will recognize that the invention can be practiced without one or more of the specific details, or with other components, systems, etc. In other instances, well-known structures or operations are not shown, or are not described in detail, to avoid obscuring aspects of the invention.

FIG. 1 is a block diagram of communication architecture 100 including a network 104 coupled among portable communication devices 102a, 102b, and 102c (collectively referred to as “communication device 102” or “communication devices 102”) and the network components 106 of a communication service provider or carrier, but is not so limited. The portable communication devices 102 include, for example, personal computers, portable computing devices, cellular telephones, portable telephones, portable communication devices, subscriber devices or units, and personal digital assistants. The terms “portable communication device” and “communication device” used herein include all such devices and equivalents, and are not limited to communication devices that are wireless. The network 104 and network components 106 can be any of a number of networks and the corresponding network components known in the art including, but not limited to, local area networks (LANs), metropolitan area networks (MANs), wide area networks (WANs), proprietary networks, backend networks, and the Internet.

Components of the communication devices 102 include, but are not limited to, a processor 110 coupled among a transceiver 112, at least one memory or memory device 114, a user interface 116, and a SIM/UIM card 118, which is also referred to as a SIM/UIM. Alternatively, the SIM/UIM card 118 also includes any of portable digital data storage devices, portable memory devices, smart cards, and compact flash memory devices. The transceiver 112 includes at least one transmitter and receiver circuit (not shown), each of which couple to provide for the transfer of information between the communication device 102 and the network 104 via an antenna (not shown). The processor 110 represents at least one processor that can be a component of a controller (not shown), but is not so limited.

The memory 114 of an embodiment typically includes a read-only memory (ROM) and a random access memory (RAM) (not shown). The ROM hosts the operational programs for controlling operations and functions of the communication device 102, but is not so limited. One operational program, for example, forms a control subsystem that includes a dynamic binding algorithm 124 for use in binding or forming electronic associations between the SIM/UIM card 118 and the communication device 102, as described in detail below. One skilled in the art recognizes that the memory 114 can be any of a number of commercially available memory types assembled in any of a number of configurations.

Each communication device 102 also includes an embedded digital signature, also referred to as a digital signature or embedded signature, embedded or stored in an area of the memory 114. The embedded digital signature uniquely identifies the communication device 102, as described below in detail. The embedded digital signature is assigned and stored by the device manufacturer or distributor.

The user interface 116 is for use in conveying information between a user and the communication device 102. The user interface 116 includes, for example, at least one of a microphone, a speaker, a data port, a display and a keypad (none of which is separately shown). One skilled in the art recognizes that the display and keypad portions of the user interface 116 can be of any type used to display and input information, respectively.

The SIM/UIM card 118 of an embodiment is removeably coupled to the communication device 102 by placing or inserting the SIM/UIM card 118 into a designated area of the communication device 102. The SIM/UIM card 118 can be a full-size card or, alternatively, a chip-sized card. When inserted into the communication device 102, the SIM/UIM card 118 couples to at least one of a SIM/UIM card reader, a SIM/UIM card application programming interface (API), and other devices capable of reading information from and writing information to the SIM/UIM card 118. By inserting the SIM/UIM card 118 into the communication device 102, the user couples the SIM/UIM card 118 to the communication device 102, thereby enabling the communication device 102 to receive calls, make calls, and access other subscriber services via a corresponding network(s).

The SIM/UIM card 118 includes a card memory or card memory area 128, but is not so limited. The card memory 128 can be at least one of RAM and ROM. One skilled in the art recognizes that the card memory 128 can be any of a number of commercially available memory types functioning in any number of configurations.

The card memory 128, in addition to storing subscriber and billing information of the SIM/UIM card user or subscriber, includes at least one data file or file referred to herein as a binding information file 138, or binding file 138, because the file stores information of the association between the SIM/UIM card 118 and the communication device 102. As such, components of the communication device 102 like the control subsystem assemble the binding information relating to a particular SIM/UIM card/communication device combination and store the binding information to the binding file 138. Thus, the binding information enables the SIM/UIM card 118 to provide personal mobility, so that the user can have access to subscribed services irrespective of a specific communication device. By inserting the SIM/UIM card 118 into any communication device 102 configured to receive the SIM/UIM card 118, the user is able to receive calls, make calls, and access other subscribed services regardless of the ownership of the communication device.

For example, when a SIM/UIM card is coupled with a first communication device, and the SIM/UIM card/device combination register for operation within a corresponding communication network, information of this first association is assembled and stored in the binding information file. When the SIM/UIM card is subsequently coupled with a second communication device, and the SIM/UIM card/device combination register for operation within a corresponding communication network, information of this second association is also assembled and stored in the binding information file. The information of the associations, the binding information, generally includes SIM/UIM card identification information (also referred to as subscriber identification information) and communication device identification information. The binding information also includes a device identification (DID) assigned to the combination of the SIM/UIM identification information and the device identification information, as described below. The contents of the binding information file are stored or arranged in accordance with techniques known in the art.

In the communication network, each communication device is assigned a mobile subscriber identification (MSI) which uniquely identifies the communication device from other communication devices operating in the network. One such identifier is the International Mobile Subscriber Identification number (IMSI). The SIM/UIM card 118 includes the International Mobile Subscriber Identity (IMSI) used to identify the subscriber to the service provider, a secret key for authentication, and other information. Likewise, the communication device 102 is uniquely identified by an International Mobile Equipment Identity (IMEI) stored in the device memory 114; however, the IMEI and the IMSI are independent, thereby allowing personal mobility.

The subscriber identification information referenced herein includes, but is not limited to, at least one of an International Mobile Subscriber Identity (IMSI), a Mobile Country Code (MCC), a Mobile Network Code (MNC), a Mobile Station Identification Number (MSIN), a Mobile Station International Integrated Service Digital Network (ISDN) Number (MSISDN), a Number Assignment Module (NAM), and other information of the particular user or subscriber. The communication device identification information of an embodiment referenced herein includes at least one of an International Mobile Equipment Identity (IMEI), a Type Approval Code (TAC), a Final Assembly Code (FAC), a Serial Number (SNR), an Electronic Serial Number (ESN), an embedded digital signature, a device model, information of a software version of the portable communication device, and configuration information of the portable communication device, but is not so limited.

In operation, the network components 106 transmit and receive information in the form of signals or information streams to and from the communication devices 102 located within a geographic service area. When the network 104 is a cellular communication network, the network components 106 include a fixed site transceiver (not separately shown) and the geographic service area is fixed as the cell served by the fixed site transceiver. The signals transmitted between network components 106 and the communication devices 102 include voice signals, data signals, subscriber identification and billing information, but are not so limited.

As described above, a problem with typical SIM/UIM cards is that they can only be read by particular communication devices and are therefore not completely interchangeable among any communication device designed for operation with a SIM/UIM card. The communication devices, systems, and methods described herein reduce or eliminate this shortcoming by dynamically binding a user's SIM/UIM card to any number of communication devices using the binding information of the binding information file so that the information of the SIM/UIM card can be used across numerous communication devices, as described below.

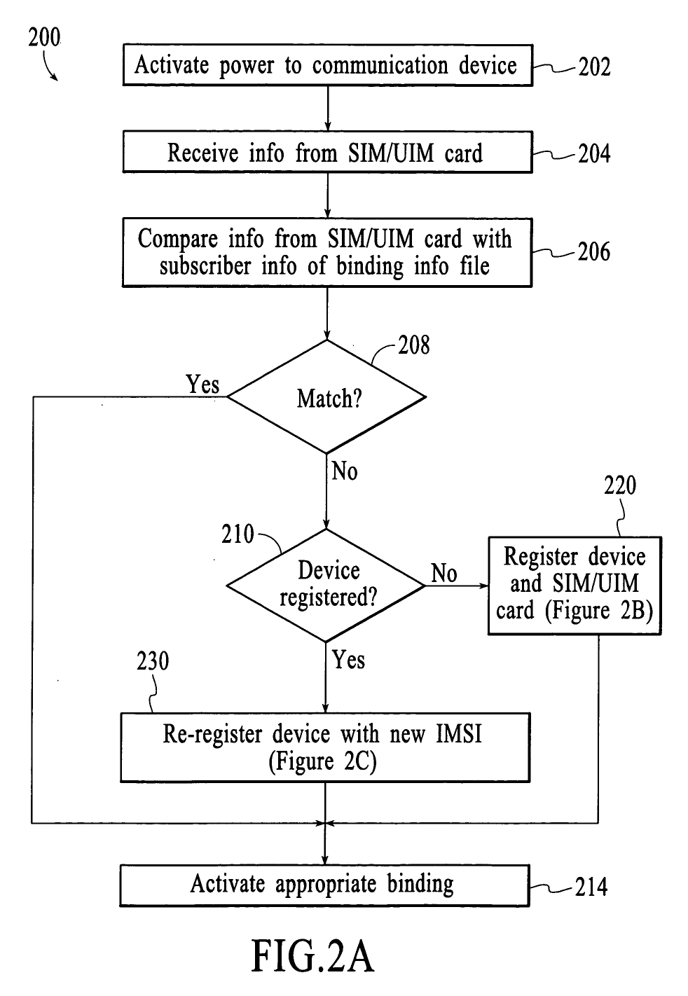

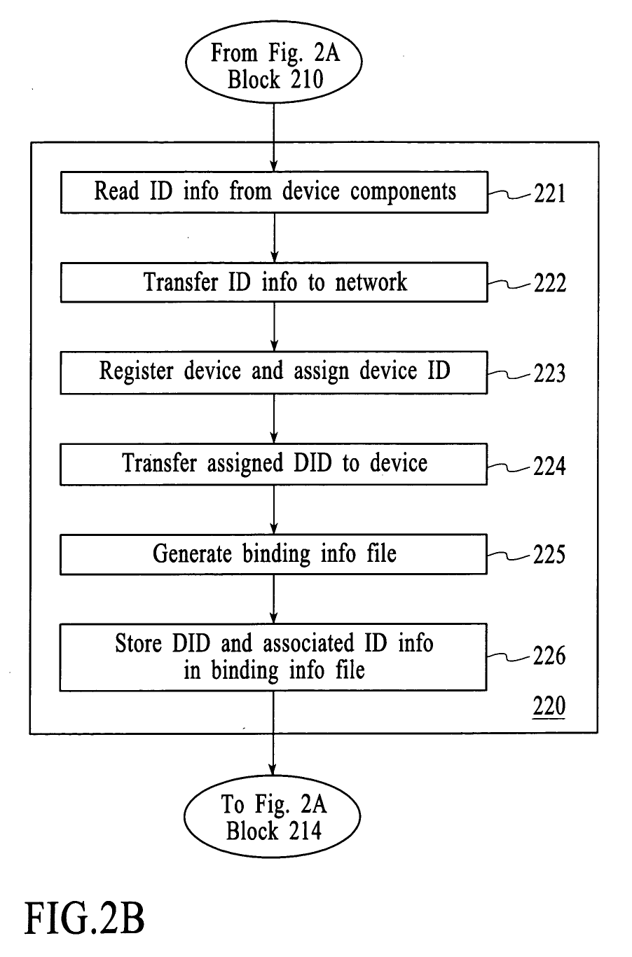

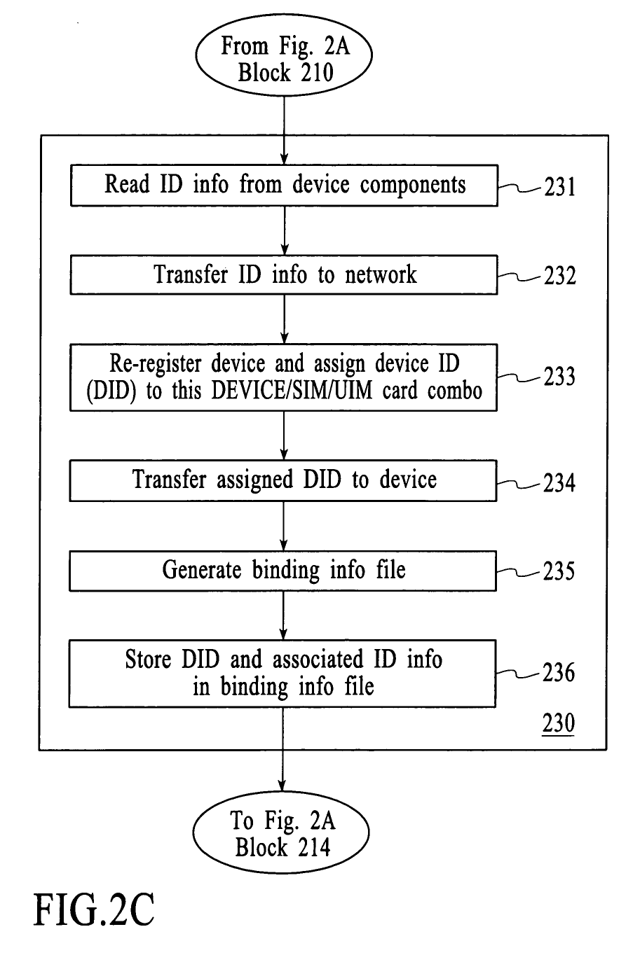

FIGS. 2A, 2B, and 2C show a flow diagram 200 for dynamically binding SIM/UIM cards to portable communication devices, under the embodiment of FIG. 1. In operation, a user places the communication device in an operational state, for example by activating the “power” switch or button of the device, at block 202. The communication device is coupled to a SIM/UIM card that has been assigned to the user, or subscriber, but is not so limited. Upon activation, the communication device of an embodiment activates or calls a power-up or boot sequence.

During the boot sequence, the control subsystem receives or reads information from the SIM/UIM card, at block 204. The information from the SIM/UIM card includes the SIM/UIM serial number and/or IMSI as well as any binding information from the binding information file. As described above, the binding information includes SIM/UIM card identification information (the SIM/UIM serial number and IMSI, for example), communication device identification information, and the DID assigned to the combination of the SIM/UIM identification information and the device identification information. The SIM/UIM card serial number and/or the IMSI are compared to the SIM/UIM card identification information found in the binding information file, at block 206. A match between the SIM/UIM card serial number/IMSI and the corresponding information in the binding information file indicates that the combination of the communication device and the SIM/UIM card are registered for service with the network, at block 208; the corresponding binding is activated, at block 214.

The absence of a match between the SIM/UIM card serial number/IMSI and the corresponding information in the binding information file, at block 208, indicates that the combination of the communication device and the SIM/UIM card are not registered for service with the network. As such, the control subsystem subsequently or simultaneously determines whether the communication device is registered with the communication network, at block 210. The control subsystem of an embodiment makes this determination using the presence or absence of an embedded digital signature stored in components of the communication device, components like the communication device memory, for example.

The presence of an embedded digital signature indicates that the communication device is not registered with the corresponding network, in which case operation continues to initially register the communication device with the corresponding network, at block 220, as further described below. The absence of an embedded digital signature indicates that the communication device is registered with the corresponding network but is not registered in combination with the currently coupled SIM/UIM card, in which case operation continues to re-register the communication device with the currently coupled SIM/UIM card, at block 230, as further described below.

As described above, the presence of an embedded digital signature in a memory area of the communication device indicates that the communication device is not registered with the corresponding network, and operation continues to initially register the communication device with the corresponding network, at block 220. With further reference to FIG. 2B, the control subsystem or other components of the communication device under the control of at least one processor read or receive identification information of the communication device as well as SIM/UIM card identification information, at block 221. The identification information of the communication device and the SIM/UIM card identification, described above, can be read or received from any number of components of the communication device.

The gathered identification information is transferred to the network or communication service provider, at block 222, after being assembled into a data stream. The transfer of the gathered identification information automatically occurs via at least one of a wireless coupling, a wired coupling, and a hybrid wireless/wired coupling between the communication device and the service provider. The network components of the service provider register the device and the coupled SIM/UIM card with the network, at block 223, using the identification information received via the data stream. This registration enables the SIM/UIM card/communication device combination to subsequently operate to transmit and receive information via the network. Upon registering the device and the SIM/UIM card, the network components assign a device identification (DID) to the SIM/UIM card/communication device combination.

The network components transfer the assigned DID to the communication device, at block 224. Upon receipt of the DID, the control subsystem or other components of the communication device generate a binding information file in a memory area of the SIM/UIM card, at block 225. Alternatively, the binding information file can already be present in the SIM/UIM card in which case the components identify an area of the binding information file for storage of this particular binding information. In other alternative embodiments where a binding information file exists in the SIM/UIM card, components of the communication device can segment the file or generate sub-files corresponding to the binding information of particular SIM/UIM card/communication device combinations. The DID is written to or stored in the binding information file or an identified portion of the binding information file along with the corresponding SIM/UIM card identification information and the identification information of the communication device, at block 226. Thus, the binding information file now includes binding information for a binding or association between the communication device and a particular SIM/UIM card, where the binding information includes the device identification information, the SIM/UIM card identification information, and the DID.

Following completion of the initial registration process, at block 226, and with reference to FIG. 2A, components of the communication device activate the binding between the communication device and the coupled SIM/UIM card, at block 214. The activated binding supports access to network services by the communication device.

As described above, the absence of an embedded signature stored in components of the communication device, at block 210, indicates that the communication device is registered with the corresponding network. However, the absence of a match between the SIM/UIM card serial number/IMSI and the corresponding information in the binding information file, at block 208, indicates that the, combination of the communication device and the SIM/UIM card are not registered for service with the network. In this scenario, operation continues to re-register the communication device with the currently coupled SIM/UIM card, at block 230.

With further reference to FIG. 2C, components of the communication device under the control of at least one processor read or receive identification information of the communication device as well as SIM/UIM card identification information, at block 231. The identification information can be read or received from any number of components of the communication device. The gathered identification information is transferred to the network or communication service provider, at block 232, after being assembled into a data stream. The transfer of the gathered identification information automatically occurs via at least one of a wireless coupling, a wired coupling, and a hybrid wireless/wired coupling between the communication device and the service provider.

Upon receipt of the gathered identification information, the network components of the service provider re-register the device, with the currently coupled SIM/UIM card, for operation on the network, at block 233. This registration enables the SIM/UIM card/communication device combination to subsequently operate to transmit and receive information via the network. Upon registering the device and the SIM/UIM card, the network components assign a device identification (DID) to the SIM/UIM card/communication device combination.

The network components transfer the assigned DID to the communication device, at block 234. Upon receipt of the DID, components of the communication device generate a binding information file in a memory area of the SIM/UIM card, at block 235. Alternatively, the binding information file can already be present in the SIM/UIM card in which case the components identify an area of the binding information file for storage of this particular binding information. The DID is written to or stored in the binding information file or an identified portion of the binding information file along with the corresponding SIM/UIM card identification information and the identification information of the communication device, at block 236. Thus, the binding information file now includes binding information for a binding or association between the communication device and the currently coupled SIM/UIM card, where the binding information includes the device identification information, the SIM/UIM card identification information, and the DID.

Following completion of the re-registration process, at block 236, and with reference to FIG. 2A, components of the communication device activate the binding between the communication device and the coupled SIM/UIM card, at block 214. The activated binding supports access to network services by the communication device.

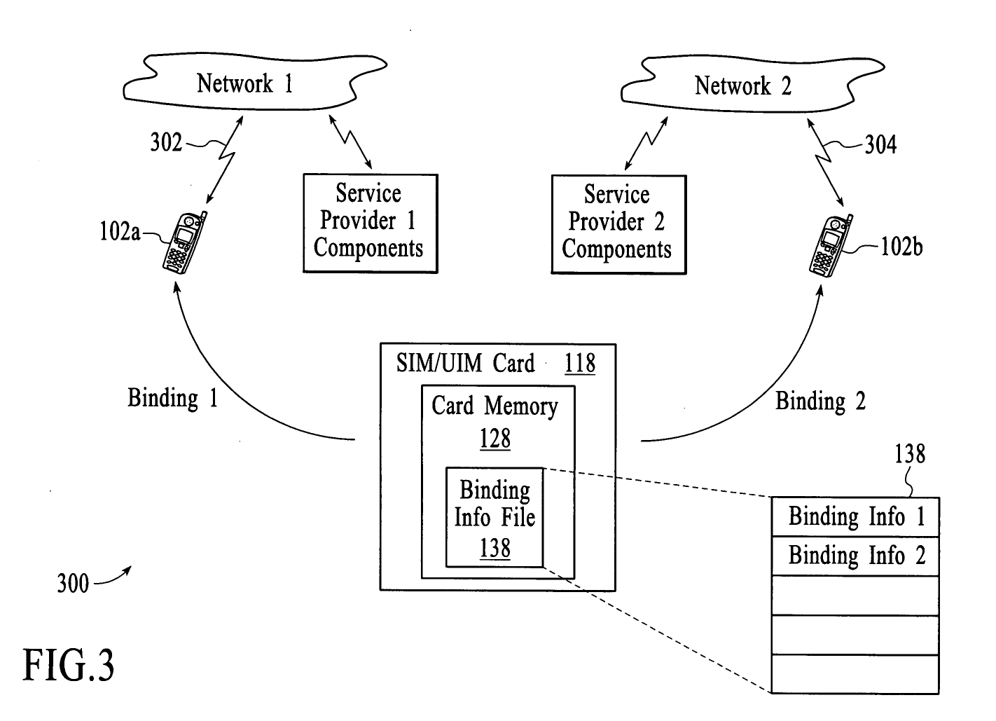

As described above, the control subsystem of the communication device of an embodiment supports the use of a single identity module, for example a Subscriber Identity Module (SIM)/User Identity Module (UIM), across many devices. FIG. 3 is a block diagram 300 of an example including a SIM/UIM card 118 that dynamically binds to multiple portable communication devices 102a and 102b, under the embodiments of FIG. 1 and FIGS. 2A, 2B, and 2C. This example is presented to clarify operation of the control subsystem and the dynamic binding or association described above, and is in no way to limit the invention claimed below.

This example includes two networks, network 1 and network 2, each being associated with a communication device 102a and 102b, respectively. Further each of network 1 and network 2 are coupled to service provider components 1 and service provider components 2, respectively. Each of network 1 and network 2 operate with different protocols, necessitating use of a different communication device 102a and 102b to access the services of the respective network. A user has purchased both communication devices 102a and 102b along with a single SIM/UIM card 118. This example assumes that neither communication device 102a nor the SIM/UIM card 118 is registered with network 1. Further, this example assumes that communication device 102b is registered with network 2 while the SIM/UIM card 118 is not registered with network 2. Initially the SIM/UIM card 118 does not includc any binding information in the binding file as it is not registered with any network and not associated with any communication device 102a and 102b.

The user begins by inserting the SIM/UIM card 118 into communication device 102a, and activating the “power” switch or button of the device. In response, the communication device 102a initiates an initial boot sequence. During the boot sequence, components of the communication device 102a, for example the control subsystem under control of at least one processor, receive or read information from the SIM/UIM card 118. The SIM/UIM card information includes the SIM/UIM serial number and/or IMSI; no binding information is read from the SIM/UIM card as none is present on the card.

Comparison of the SIM/UIM serial number and/or IMSI with the binding information does not result in a match because of the absence of any binding information. The absence of a match between the SIM/UIM card serial number/IMSI and the corresponding information in the binding information file indicates that the combination of the communication device 102a and the SIM/UIM card 118 is not registered for service with network 1. As such, the control subsystem makes a determination as to whether the communication device 102a is registered with network 1 by reading a prespecified area of the communication device memory for an embedded digital signature. In this example, an embedded digital signature is located in the memory of communication device 102a, indicating that communication device 102a is not registered with network 1.

Along with the embedded digital signature, the control subsystem of communication device 102a reads or receives identification information of communication device 102a as well as SIM/UIM card identification information from SIM/UIM card 118. The identification information of the communication device and the SIM/UIM card identification information are described above. The control subsystem assembles or generates a data stream using the embedded digital signature, the identification information of the communication device, and the SIM/UIM card identification information. The data stream is transmitted to the service provider 1 components via the wireless coupling 302.

The service provider 1 components register the communication device 102a and the coupled SIM/UIM card 118 with network 1 using the information of the data stream. This registration enables the SIM/UIM card 118/communication device 102a combination to subsequently operate to transmit and receive information via network 1. The information includes voice and data, but is not so limited. Following or simultaneous with registration, the service provider 1 components assign a device identification (DID) to the SIM/UIM card 118/communication device 102a combination.

The service provider 1 components transfer the assigned DID to the communication device 102a where, upon receipt, the control subsystem generates or identifies a binding information file 138 in a memory area 128 of the SIM/UIM card 118. The DID is written to or stored in an area of the binding information file along with the corresponding SIM/UIM card identification information and the identification information of the communication device, collectively this information is binding information 1. Thus, the binding information file now includes binding information 1 which is information of a binding (binding 1) or association between the communication device 102a and the SIM/UIM card 118. Following completion of the initial registration process, the control subsystem activates binding 1 between the communication device 102a and the coupled SIM/UIM card 118. The activation of binding 1 supports access to network services by the communication device 102a.

Continuing with the example, the user now finds himself/herself in a geographical area where access to information services is available via network 2 instead of network 1. In response, the user turns communication device 102a “off” in order to remove the SIM/UIM card 118. As part of the power-down sequence, communication device 102a deactivates binding 1 with network 1. The user now removes the SIM/UIM card 118 from communication device 102a, inserts the SIM/UIM card 118 into communication device 102b, and activates the “power” switch or button of communication device 102b.

In response, the communication device 102b initiates an initial boot sequence. During the boot sequence, components of the communication device 102b, for example the control subsystem under control of at least one processor, receive or read information from the SIM/UIM card 118. The SIM/UIM card information includes the SIM/UIM serial number and/or IMSI as well as any binding information. As the SIM/UIM card only includes binding information 1 of the association of the SIM/UIM card 118 to communication device 102a at this time, binding information 1 is read.

Comparison of the SIM/UIM serial number and/or IMSI with the binding information 1 does not result in a match because the binding information 1 includes identification information of communication device 102a. The absence of a match between the SIM/UIM card serial number/IMSI and the corresponding information in the binding information file indicates that the combination of the communication device 102b and the SIM/UIM card 118 is not registered for service with network 2. As such, the control subsystem makes a determination as to whether the communication device 102b is registered with network 2 by reading a prespecified area of the communication device memory for an embedded digital signature. In this example, an embedded digital signature is not located in the memory of communication device 102b, indicating that communication device 102b is registered with network 2.

The absence of an embedded signature stored in components of communication device 102b indicates that communication device 102b is registered with network 2. However, the absence of a match between the SIM/UIM card serial number/IMSI and information of the binding information file indicates that the combination of communication device 102b and the SIM/UIM card 118 are not registered for service with network 2. Consequently, the control subsystem of communication device 102b re-registers the communication device 102b with the SIM/UIM card 118.

Re-registration begins with the control subsystem of communication device 102b reading or receiving identification information of communication device 102b as well as SIM/UIM card identification information from SIM/UIM card 118. The identification information of the communication device and the SIM/UIM card identification information are described above. The control subsystem assembles or generates a data stream using the identification information of the communication device and the SIM/UIM card identification information. The data stream is transmitted to the service provider 2 components via the wireless coupling 304.

The service provider 2 components re-register the communication device 102b and the coupled SIM/UIM card 118 with network 2 using the information of the data stream. This re-registration enables the SIM/UIM card 118/communication device 102b combination to subsequently operate to transmit and receive information via network 2. Following or simultaneous with registration, the service provider 2 components assign a device identification (DID) to the SIM/UIM card 118/communication device 102b combination.

The service provider 2 components transfer the assigned DID to the communication device 102b where, upon receipt, the control subsystem identifies the binding information file 138 in the memory area 128 of the SIM/UIM card 118. The DID is written to or stored in an area of the binding information file along with the corresponding SIM/UIM card identification information and the identification information of the communication device, collectively this information is binding information 2. Thus, the binding information file now includes binding information 2, which is information of a binding (binding 2) or association between the communication device 102b and the SIM/UIM card 118, in addition to binding information 1. Following completion of the initial registration process, the control subsystem activates binding 2 between the communication device 102b and the coupled SIM/UIM card 118. The activation of binding 2 supports access to network services by the communication device 102b.

Continuing with the example, the user now finds himself/herself in a geographical area where access to information services is again available via network 1 instead of network 2. In response, the user turns communication device 102b “off” in order to remove the SIM/UIM card 118. As part of the power-down sequence, communication device 102b deactivates binding 2 with network 2. The user now removes the SIM/UIM card 118 from communication device 102b, inserts the SIM/UIM card 118 into communication device 102a, and activates the “power” switch or button of communication device 102a.

In response to the application of device power, the communication device 102a initiates an initial boot sequence. During the boot sequence, the control subsystem under control of at least one processor receives or reads information from the SIM/UIM card 118. The SIM/UIM card information includes the SIM/UIM serial number and/or IMSI as well as any binding information. As the SIM/UIM card includes binding information 1 of the association of the SIM/UIM card 118 to communication device 102a, binding information 1 is read.

Comparison of the SIM/UIM serial number and/or IMSI with binding information 1 results in a match because binding information 1 includes identification information of communication device 102a. The match between the SIM/UIM card serial number/IMSI and binding information 1 indicates that the combination of the communication device 102a and the SIM/UIM card 118 is registered for service with network 1. As such, the control subsystem activates binding 1 between the communication device 102a and the coupled SIM/UIM card 118. The activation of binding 1 supports access to network services by the communication device 102a.

Aspects of the control subsystem of an embodiment may be implemented as functionality programmed into any of a variety of circuitry, including programmable logic devices (PLDs), such as field programmable gate arrays (FPGAs), programmable array logic (PAL) devices, electrically programmable logic and memory devices and standard cell-based devices, as well as application specific integrated circuits (ASICs). Some other possibilities for implementing aspects of the control subsystem of an embodiment include: microcontrollers with memory (such as electronically erasable programmable read only memory (EEPROM)), embedded microprocessors, firmware, software, etc. Furthermore, aspects of the control subsystem of an embodiment may be embodied in microprocessors having software-based circuit emulation, discrete logic (sequential and combinatorial), custom devices, fuzzy (neural) logic, quantum devices, and hybrids of any of the above device types. Of course the underlying device technologies may be provided in a variety of component types, e.g., metal-oxide semiconductor field-effect transistor (MOSFET) technologies like complementary metal-oxide semiconductor (CMOS), bipolar technologies like emitter-coupled logic (ECL), polymer technologies (e.g., silicon-conjugated polymer and metal-conjugated polymer-metal structures), mixed analog and digital, etc.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” and words of similar import, shall refer to this patent as a whole and not to any particular portions of this patent. When the word “or” is used in reference to a list of two or more items, that word covers all of the following interpretations of the word: any of the items in the list, all of the items in the list and any combination of the items in the list.

The above description of illustrated embodiments of the control subsystem is not intended to be exhaustive or to limit the control subsystem of an embodiment to the precise form disclosed. While specific embodiments of, and examples for, the control subsystem are described herein for illustrative purposes, various equivalent modifications are possible within the scope of the control subsystem, as those skilled in the relevant art will recognize. The teachings of the control subsystem of an embodiment provided herein can be applied to other processing systems and communication systems, not only for the processing systems described above.

The elements and acts of the various embodiments described above can be combined to provide further embodiments. These and other changes can be made to the control subsystem of an embodiment in light of the above detailed description.

In general, in the following claims, the terms used should not be construed to limit the control subsystem of an embodiment to the specific embodiments disclosed in the specification and the claims, but should be construed to include all processing systems that operate under the claims. Accordingly, the control subsystem of an embodiment is not limited by the disclosure, but instead the scope of the control subsystem is to be determined entirely by the claims.

While certain aspects of the control subsystem of an embodiment are presented below in certain claim forms, the inventors contemplate the various aspects of the control subsystem in any number of claim forms. For example, while only one aspect of the control subsystem of an embodiment is recited as embodied in a computer readable medium, other aspects may likewise be embodied in a computer readable medium. Accordingly, the inventors reserve the right to add additional claims after filing the application to pursue such additional claim forms for other aspects of the control subsystem of an embodiment.

1. A portable communication device comprising:
at least one processor coupled to at least one transceiver; and
an identity module removeably coupled to the processor, wherein information of the identity module controls operation of the device, wherein the processor receives binding information including identification information from components of the device and subscriber information from the identity module, forms an association between the device and the module by assigning a device identification (DID) to the binding information, generates at least one binding file in a memory area of the module, and stores the device identification and the binding information in the binding file.

2. The device of claim 1, wherein the identity module is at least one of a Subscriber Identity Module (SIM), a SIM card, a User Identity Module (UIM), a UIM card, a digital data storage device, a smart card, a compact flash memory device, and a portable memory device.

3. The device of claim 1, wherein the identification information includes at least one of an International Mobile Equipment Identity (IMEI), a Type Approval Code (TAC), a Final Assembly Code (FAC), a Serial Number (SNR), an Electronic Serial Number (ESN), an embedded digital signature, a device model, information of a software version of the portable communication device, and configuration information of the portable communication device.

4. The device of claim 1, wherein the memory area of the module includes a non-volatile memory.

5. The device of claim 1, wherein the device is at least one of personal computers, portable computing devices, cellular telephones, portable telephones, portable communication devices, and personal digital assistants.

6. A communication device comprising a control subsystem that forms an electronic linkage between the device and a removeably coupled identity module, wherein the control subsystem reads identification information of the components and the identity module and, in response, dynamically links the device to the identity module by writing the identification information to a binding file of the identity module along with an assigned device identification corresponding to the device and identity module combination, wherein information of the binding file controls subsequent activation and operation of the device in a communication network.

7. A portable communication device comprising:
means for receiving identification information from components of the device;
means for receiving subscriber information from a module removeably coupled to the device;
means for electronically associating the device with the module by assigning a device identification (DID) to binding information including the identification information and the subscriber information; and
means for generating a binding file in a memory area of the module and storing the device identification and the binding information in the binding file.

8. A communications system comprising:
a communications network including a plurality of network components; and
at least one personal communication device coupled to the network for use by subscribers in transmitting and receiving information, the communication device including at least one processor coupled among at least one transceiver and a removeable identity module so that information of the identity module controls operation of the communication device, wherein the processor receives binding information including identification information from components of the communication device and subscriber information from the identity module and transmits the binding information to the network components, wherein the processor receives a device identification (DID) from the network components and dynamically binds the communication device with the identity module by generating at least one binding file in a memory area of the identity module and storing the device identification along with the associated binding information in the binding file.

9. The system of claim 8, wherein the processor is further configured to:
determine if the communication device and the identity module are registered to provide service on the communications network by comparing the subscriber information with the binding information;
in response to a determination that the communication device and the identity module are registered, activating the communication device and the identity module using information of the binding file; and
in response to a determination that at least one of the communication device and the identity module are not registered, registering at least one of the communication device and the identity module and generating a binding among the communication device and the identity module by associating a device identification with the identification information and the subscriber information, and storing the device identification, the identification information, and the subscriber information in the binding file.

10. The system of claim 8, further comprising a data stream including the binding information, wherein the data stream is generated by the communication device and transmitted to at least one of the network components via at least one coupling between the communication device and the network components.

11. The system of claim 8, wherein the coupling among the network components and the personal communication device is at least one of wireless connections, wired connections, and hybrid wireless/wired connections.

12. The system of claim 8, wherein the communications network includes local area networks (LANs), metropolitan area networks (MANs), wide area networks (WANs), proprietary networks, backend networks, and the Internet.

13. A method for forming dynamic associations among portable modules and portable communication devices, comprising:
receiving identification information from at least one component of a portable communication device;
receiving identification information from a portable module coupled to the portable communication device;
assigning a device identification to the association between the portable module and the portable communication device;
generating a binding state file in a memory area of the portable module; and
storing the device identification and the identification information of the portable module and the portable communication device in the binding state file.

14. The method of claim 13, further comprising determining if the portable communication device and the coupled portable module are registered to provide service on a communications network.

15. The method of claim 14, wherein the determination includes determining whether an embedded digital signature is stored in the components of the portable communication device.

16. The method of claim 14, wherein the determination includes comparing the identification information of the portable module with information of the binding state file.

17. The method of claim 14, further comprising registering the portable communication device to provide service on the communications network when it is not registered to provide service, wherein registration of the portable communication device includes providing an embedded digital signature to components of the communications network and using the embedded digital signature to activate subscriber services to the portable communication device.

18. The method of claim 14, further comprising re-registering the portable communication device to provide service on the communications network with the coupled portable module when the portable communication device is registered with the communication network and there is an absence of data of an association between the portable communication device and the coupled portable module.

19. The method of claim 13, further comprising:
generating a data stream in the portable communication device, the data stream including the identification information of the portable module and the portable communication device;
transferring the data stream to at least one server via at least one coupling with the server; and
in response to assigning a device identification to the association, transferring the device identification to the portable communication device.

20. The method of claim 13, wherein a component of the portable communication device assigns the device identification to the association, where the device identification is transmitted to at least one server via at least one coupling with the server.

21. The method of claim 13, further comprising:
receiving identification information from at least one component of a first portable communication device;
receiving identification information from a portable module coupled to the first portable communication device;
assigning a first device identification to the association between the portable module and the first portable communication device;
generating a first binding state file in a memory area of the portable module; and
storing the first device identification and the identification information of the portable module and the first portable communication device in the first binding state file.

22. The method of claim 21, further comprising:
transferring the portable module from the first portable communication device to a second portable communication device;
receiving identification information from at least one component of the second portable communication device;
receiving identification information from the portable module;
assigning a second device identification to the association between the portable module and the second portable communication device;
generating a second binding state file in the memory area of the portable module; and
storing the second device identification and the identification information of the portable module and the second portable communication device in the second binding state file.

23. The method of claim 13, wherein the portable module is at least one of a Subscriber Identity Module (SIM), a SIM card, a User Identity Module (UIM), a UIM card, a digital data storage device, a smart card, a compact flash memory device, and a portable memory device.

24. The method of claim 13, wherein the identification information of the portable communication device includes at least one of an International Mobile Equipment Identity (IMEI), a Type Approval Code (TAC), a Final Assembly Code (FAC), a Serial Number (SNR), an Electronic Serial Number (ESN), an embedded digital signature, a device model, information of a software version of the portable communication device, and configuration information of the portable communication device.

25. The method of claim 13, wherein the identification information of the portable module includes at least one of an International Mobile Subscriber Identity (IMSI), a Mobile Country Code (MCC), a Mobile Network Code (MNC), a Mobile Station Identification Number (MSIN), a Mobile Station International Integrated Service Digital Network (ISDN) Number (MSISDN), a Number Assignment Module (NAM), and information of a subscriber.

26. A method for controlling operation of a portable communication device with a communication network, comprising:
receiving identification information from components of the device and subscriber information from at least one memory card in response to placing the device in an operational state, wherein the memory card is removeably coupled to the components;
determining if at least one of the device and the memory card are registered to provide service on the communication network by comparing the subscriber information with information of a binding file of the memory card;
in response to a determination that the device and the memory card are registered, activating the device and the memory card using information of the binding file; and
in response to a determination that at least one of the device and the memory card are not registered, registering at least one of the device and the memory card and generating a binding among the device and the memory card by associating a device identification with the identification information and the subscriber information, and storing the device identification, the identification information, and the subscriber information in the binding file.

27. The method of claim 26, wherein registering at least one of the device and the memory card includes initially registering the device, wherein initial registration of the device comprises:
reading an embedded digital signature from the components of the device;
transmitting the embedded digital signature to the communication network; and
activating subscriber services to the device and assigning the device identification to a combination of the device and the coupled memory card in response to receiving the embedded digital signature.

28. The method of claim 26, wherein registering at least one of the device and the memory card includes re-registering the device, wherein re-registration of the device comprises:
activating subscriber services to the device in response to receipt of the identification information from a registered device and the subscriber information of an unregistered memory card; and
assigning the device identification to a combination of a registered device and an unregistered memory card coupled to the registered device.

29. The method of claim 26, wherein a binding between a first device and the memory card is associated with information of a first memory area of the binding file, wherein a binding between a second device and the memory card is associated with information of a second memory area of the binding file.

30. A computer readable medium including executable instructions which, when executed in a processing system, dynamically forms bindings between a portable module and portable communication devices by:
receiving identification information from at least one component of a portable communication device;
receiving identification information from a portable module coupled to the portable communication device;
assigning a device identification to the association between the portable module and the portable communication device;
generating a binding state file in a memory area of the portable module; and
storing the device identification and the identification information of the portable module and the portable communication device in the binding state file.
